(19) United States
(12) Patent Application Publication
(10) Pub. No.: US 2015/0298364 A1
(43) Pub. Date: Oct. 22, 2015

(54) METHOD OF MOULDING AND A CORE PLUG FOR USE IN THE METHOD

(71) Applicant: Airbus Operations Limited, Bristol (GB)

(72) Inventor: Simon PARKER, Bristol (GB)

(21) Appl. No.: 14/688,517

(22) Filed: Apr. 16, 2015

(30) Foreign Application Priority Data
Apr. 17, 2014 (GB) 1406967.8

(51) Int. Cl. B29C 33/38

(52) U.S. Cl. CPC B29C 33/3814; B29L 2022/00

(57) ABSTRACT

A method of moulding a component having a closed shape and defining an internal void having a predetermined size and shape is disclosed, together with a core plug for use in the method. The method comprises the steps of: (a) cutting a piece of open cell foam material to substantially match said predetermined size and shape of the internal void of a component to be moulded; (b) applying a flexible sealant to an outer surface of said cut piece of resilient open cell foam to form a closed core; (c) placing said closed core in the mould to support a component during moulding and curing; (d) generating a vacuum within the closed core to collapse it within the void after the moulded component has cured, and (e) removing the collapsed core from the molded component through an opening in said moulded component.

### BACKGROUND TO THE INVENTION

The present invention relates to a method of moulding a component. A core plug for use in the method is also disclosed.

Light weight structures formed from CFRP (carbon fibre reinforced plastic) or GFRP (glass fibre reinforced plastic) are more commonly being used in marine, aeronautical and automotive applications. Due to limitations in the moulding process and the requirement to support a moulded component internally during curing, many products made from such materials are made from a number of individually molded parts or by co-bonding/curing pre-shaped ‘green’ or ‘uncured’ structures at the same time. However, whilst co-bonding and curing results in a more integral structure, at least for those structures that have a closed shape, moulding in discrete sections is necessary so that a support structure located within the part, and which is used to support the component during the moulding and curing cycle, remains accessible and so can be removed once the manufacturing process is complete and prior to assembly of the individual parts.

Although the use of fixings of the type normally associated with metallic construction techniques are commonly employed for use in the assembly of the individually moulded parts, the use of such fixings does increase weight.

It is known to avoid the use of fixings by pre-curing the closed structures first, adding them to the assembled structure and then utilising a post curing process or post bonding process. However, this technique results in a component which is not as strong and which is technically not a monocoque structure. Another option is to support the closed structure with a light weight filler material, such as foam, which can be left in place throughout the life of the product. However, the foam can be susceptible to moisture ingress resulting in an increase in weight.

It is therefore desirable to achieve a ‘one-shot’ manufacturing technique to effectively produce a monocoque, semi-monocoque, unibody or unitary body structure. One particular application of such a technique is in the manufacture of aircraft structures and, in particular, in the manufacture of parts of the wings and fuselage. Current metallic aircraft structures are constructed from many hundreds of separate components that are usually fixed together using rivets or screw thread fixings. For example, wing skins are reinforced with stringers and ribs, with each fixing passing through a hole in the skin and stringer or skin and rib, or sometimes through all three. Whilst it is becoming more common to form the structural components of an aircraft from CFRP or GFRP or a similar product, there is still a need to reduce the number of individually moulded products that must be attached to each other once the curing step is complete and the internal mould support has been removed.

### SUMMARY OF THE INVENTION

According to the invention, there is provided a method of moulding a component having a closed shape and defining an internal void having a predetermined size and shape, the method comprising the steps of:
(a) cutting a piece of open cell foam material to substantially match said predetermined size and shape of the internal void of a component to be moulded;
(b) applying a flexible sealant to an outer surface of said cut piece of resilient open cell foam to form a closed core plug;
(c) placing said closed core plug in the mould to support a component during moulding and curing;
(d) generating a vacuum within the closed core plug to collapse it within the void after the moulded component has cured, and
(e) removing the collapsed core plug from the molded component through an opening in said moulded component.

In one embodiment, a coolant gas may be supplied through the piece of open cell foam prior to and/or during cutting in step (a), with the aim of making the material more rigid and easier to cut and/or manipulate.

In an alternative embodiment, the method includes the step of immersing or wetting the piece of foam with liquid and cooling it to freeze said liquid prior to cutting it in step (a). Again, this has the objective of increasing the rigidity of the material to make it easier to cut.

In a preferred embodiment, the method includes the step of inserting a manifold into the cut piece of open cell foam, the manifold being connectable to a vacuum and/or positive pressure source. The manifold may simply be a tube which may be pushed or inserted into the open cell foam so that the end of the tube is positioned substantially centrally within it.

Step (b) of the method may include the step of applying a vacuum within the cut piece of open cell foam during the application of sealant to draw sealant into the open cell foam structure. This increases the thickness or depth of penetration of the sealant into the foam and so may assist in completely sealing the outer surface of the foam.

In some embodiments, step (d) comprises the step of applying the vacuum in pulses during core plug removal.

A positive pressure may also be generated within the closed core plug during the moulding and/or curing process to ensure that the core fills the void completely.

According to the invention, there is also provided a core plug for use in a method of moulding a component comprising a piece of open cell foam coated with a flexible sealant so that it collapses in response to the generation of a negative pressure within the piece of open cell foam to enable the core plug to be removed from a component in its collapsed state after moulding.

### BRIEF DESCRIPTION OF THE DRAWINGS

FIG. 1 is a flowchart to illustrate the steps in the method according to an embodiment of the invention; and

FIG. 2 illustrates a cross-section taken through a core plug which is formed as part of the method described with reference to FIG. 1, together with a tube inserted therein and a vacuum/positive pressure source.

### DETAILED DESCRIPTION

Embodiments of the invention will now be described, by way of example only, with reference to the accompanying drawings.

Embodiments of the present invention provide a method of moulding a CFRP or GFRP structural component having a closed shape and an internal void. The method includes the use of a collapsible foam core plug 1 to provide support to the component during moulding and curing whilst enabling the core plug 1 to be removed from the void once the component has cured and no longer needs to be supported.

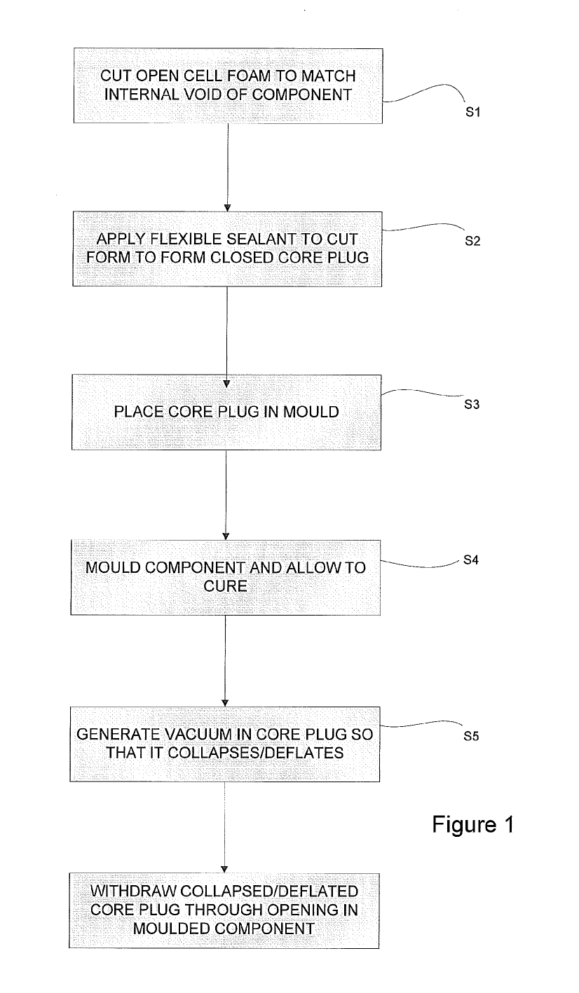

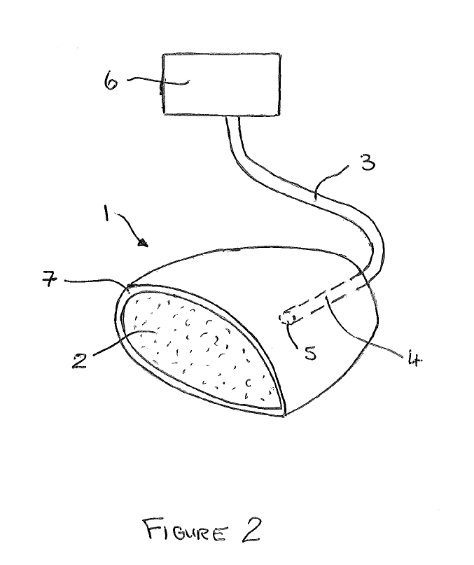

A cross-section through a core plug 1 is shown in FIG. 2. Whilst a core plug 1 of a particular shape to match the shape of a component to be moulded is illustrated in FIG. 1, it will be appreciated that the core plug 1 can take many different shapes and have many different forms. The core plug 1 has a core which is formed from an open cell foam material 2 that, after being compressed, quickly recovers its original dimensions due to its inherently resilient properties.

As part of the method, and as shown in the flowchart of FIG. 1, a piece of open cell foam 2 is cut or machined to accurate dimensions to replicate the size and shape of the internal void formed by the closed shape of the component being moulded (Step S1). The cutting or machining step can be facilitated by passing a cooling gas through the open cell foam so as to ‘freeze’ or otherwise increase its rigidity. Alternatively, the foam core 2 can be doused or immersed in water or other liquid and then frozen before machining, prior to it being allowed to dry out. The foam core 2 can be made from a number of different materials that are able to withstand the temperatures and pressures required for the moulding and curing process.

Once the foam core 2 has been sized and shaped to suit a predetermined size and shape of void within a component to be moulded, a manifold is introduced into it. For a simple component, the manifold may simply take the form of a flexible pipe or tube 3, as shown in FIG. 2, an end portion 4 of which can be pushed into the foam core 2 with the aim of positioning the open tip 5 of the end portion 4 somewhere near the overall centre of the core 2. The opposite end of the tube 3 can be as long as is necessary for the moulding process allowing it to be connected to a remote vacuum or positive pressure source 6. Once in place, it may be necessary to prevent the tube 3 from being pulled out of the core 2 using an adhesive or other sealant material. For a more complex component multiple manifolds or tubes 3 may be inserted into the foam core 2, especially if the form has ‘legs’ or ‘peninsulas’.

The next stage is to apply a coating of sealant 7 to the outer surface of the foam core 2 to form the finished core plug 1 (Step S2). A sealant 7 can be painted on, or the foam core 2 can be dipped into the sealing compound. To achieve a thicker/tougher skin, a vacuum may optionally be generated within the foam core 2 as the sealant 7 is being applied, with the aim of drawing sealant 7 into the open cell foam core 2 to a certain depth. Once application of the sealant 7 is complete and the vacuum deactivated, the foam core 2 must be allowed to vent to atmosphere so that it returns to its original shape and dimensions. Finally, the sealant 7 should be allowed to cure fully. A possible sealant 7 which may be used for this purpose is PR₁₇8₂-C₁₂ low density aerospace sealant manufactured by PPG Aerospace.

Once the sealant 7 has cured, the core plug 1 can be placed in the mould and the component formed around it so that the core plug 1 provides support to the component during the moulding process and during the subsequent curing step (Step S3. During the moulding process, it is possible to apply a positive pressure to the foam core 2 via the tube 3 so that it more closely assumes the shape of the internal void and thereby reduces the possibility of voids or dry areas in the material being cured. Vacuum or positive pressure can be varied through out the cure cycle.

Once the cure cycle is complete and/or the support provided by the core plug 1 is no longer required, it can be collapsed by applying a vacuum via the manifold or tube 3 and the vacuum source 6 to draw air out of the foam core 2 (Step S4). Once it has collapsed, the core plug 1 can be removed easily by drawing or pulling it out through a relatively small opening in the moulded component (Step S5).

Long or more complex shapes can be removed more easily by repeatedly pulsing the applied vacuum and by applying a pulling force to the core plug 1 through the opening so that the core plug 1 is gradually drawn out of the void in stages corresponding to the pulses of the applied vacuum.

It will be appreciated that the manifold or tube 3 may be inserted into the foam core 2 after the sealant 7 has been applied to it, rather than prior to the application of sealant 7, although it may also be necessary to ensure a seal is maintained at the point at which the manifold or tube 3 is inserted into the foam core 2.

Whilst the present invention has applications for a vast number of moulded products, one particular application of the moulding process of the present invention could be a shroud box attached to the wing of a passenger aircraft. A conventional shroud box is formed from a complex metallic manufacturing process and so a one shot moulding process would greatly simplify its manufacture. The process also has application in the manufacture of a moulded one-shot rib and spar construction. The difference between the methods would simply be the direction the collapsible cores are extracted after the cure process. In the case of the multi spar option spars would be removed laterally i.e. through the end ribs or in the case of the more convention one shot rib and spar solution the removal would be through a hole in the front spar.

Many modifications and variations falling within the terms of the following claims will be apparent to those skilled in the art and the foregoing description should be regarded as a description of the preferred embodiments of the invention only.

1. A method of moulding a component having a closed shape and defining an internal void having a predetermined size and shape, the method comprising the steps of:
(a) cutting a piece of open cell foam material to substantially match said predetermined size and shape of the internal void of a component to be moulded;
(b) applying a flexible sealant to an outer surface of said cut piece of resilient open cell foam to form a closed core plug;
(c) placing said closed core plug in the mould to support a component during moulding and curing;
(d) generating a vacuum within the closed core plug to collapse it within the void after the moulded component has cured, and
(e) removing the collapsed core plug from the molded component through an opening in said moulded component.

2. A method according to claim 1, including the step of supplying a coolant gas through the piece of open cell foam prior to and/or during cutting in step (a).

3. A method according to claim 1, including the step of immersing or wetting the piece of foam with liquid and cooling it to freeze said liquid prior to cutting in step (a).

4. A method according to claim 1, including the step of inserting a manifold into the cut piece of open cell foam, the manifold being connectable to a vacuum and/or positive pressure source.

5. A method according to claim 4, wherein step (b) includes the step of applying a vacuum within the cut piece of open cell foam during the application of sealant to draw sealant into the open cell foam structure.

6. A method according to claim 1, wherein step (d) comprises applying the vacuum in pulses during core plug removal.

7. A method according to claim 1, including the step of generating a positive pressure within the closed core plug during the moulding and/or curing process.

8. A core plug for use in a method of moulding a component comprising a piece of open cell foam coated with a flexible sealant so that it collapses in response to the generation of a negative pressure within the piece of open cell foam to enable the core plug to be removed from a component in its collapsed state after moulding.
